(19) United States
(12) Patent Application Publication
(10) Pub. No.: US 2012/0223653 A1
(43) Pub. Date: Sep. 6, 2012

(54) INVERTER DEVICE, DISPLAY APPARATUS LIGHTING DEVICE PROVIDED WITH SAME, AND DISPLAY APPARATUS

(75) Inventor: Shinji Matsumoto, Osaka-Shi (JP)

(73) Assignee: SHARP KABUSHIKI KAISHA, Osaka-Shi, Osaka (JP)

(21) Appl. No.: 13/509,332

(22) PCT Filed: Oct. 4, 2010
(86) PCT No.: PCT/JP2010/067330

§ 371 Date: May 11, 2012

(30) Foreign Application Priority Data
Dec. 10, 2009 (JP) 2009-280799

(51) Int. Cl. H05B 41/24

(52) U.S. Cl. 315/255

(57) ABSTRACT

Disclosed is an inverter device which is provided with a plurality of transformers and is used for driving a plurality of discharge tube lamps (L1-L6) by using each of the output voltages (VL1-VL6) of the plurality of transformers as voltages to be applied to the plurality of discharge tube lamps (L1-L6), respectively, wherein at least one of the driving frequencies of the plurality of transformers is shifted for each prescribed period of time.

### TECHNICAL FIELD

The present invention relates to an inverter device for driving a plurality of discharge tube lamps, as well as to a lighting device for a display apparatus and a display apparatus, which include the same.

### BACKGROUND ART

An inverter device used in a lighting device for a display apparatus drives a plurality of discharge tube lamps by applying a high-frequency high voltage to each of the plurality of discharge tube lamps. The plurality of discharge tube lamps are thereby lit up, and thus the lighting device for a display apparatus serves its function as a lighting device.

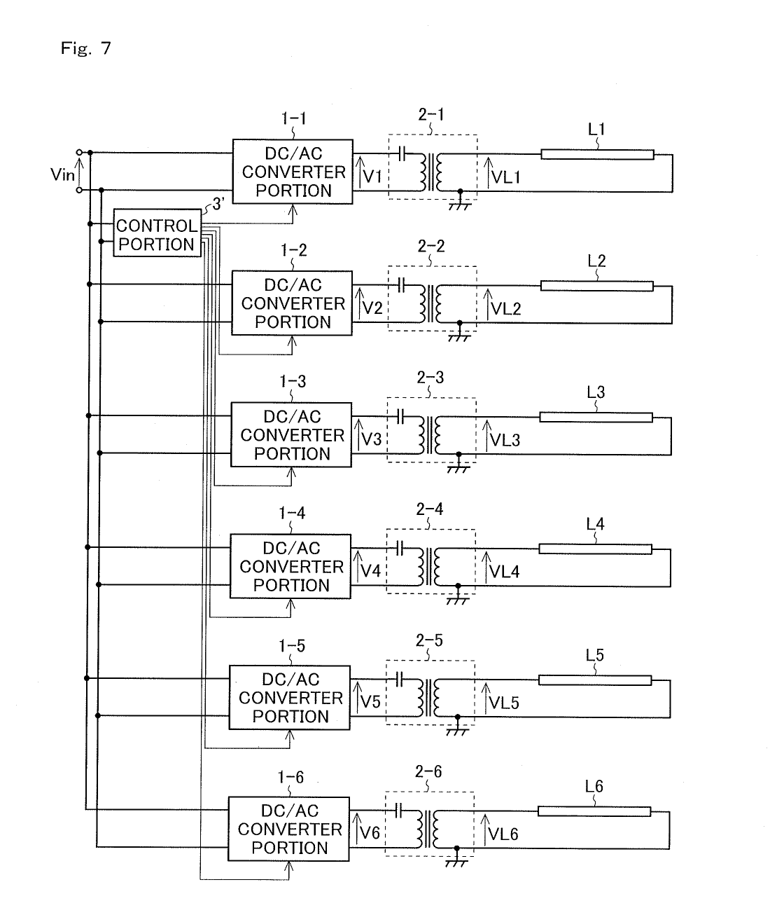

Conventional general-use inverter devices execute an in-phase driving operation to drive a plurality of discharge tube lamps. FIG. 7 shows a configuration example of a conventional general-useinverter device that performs the in-phase driving operation.

The inverter device shown in FIG. 7 is an inverter device for driving six discharge tube lamps (for example, cold cathode tube lamps) L1 to L6 and includes DC/AC converter portions 1-1 to 1-6 that each convert a direct current input voltage Vin into an alternating current voltage having a high frequency (of, for example, several tens of kHz), a booster portion 2-k that boosts an output voltage Vk of the DC/AC converter portion 1-k and applies the output voltage Vk thus boosted to a discharge tube lamp Lk, and a control portion 3′ that controls the DC/AC converter portions 1-1 to 1-6. Here, k represents a natural number from 1 to 6.

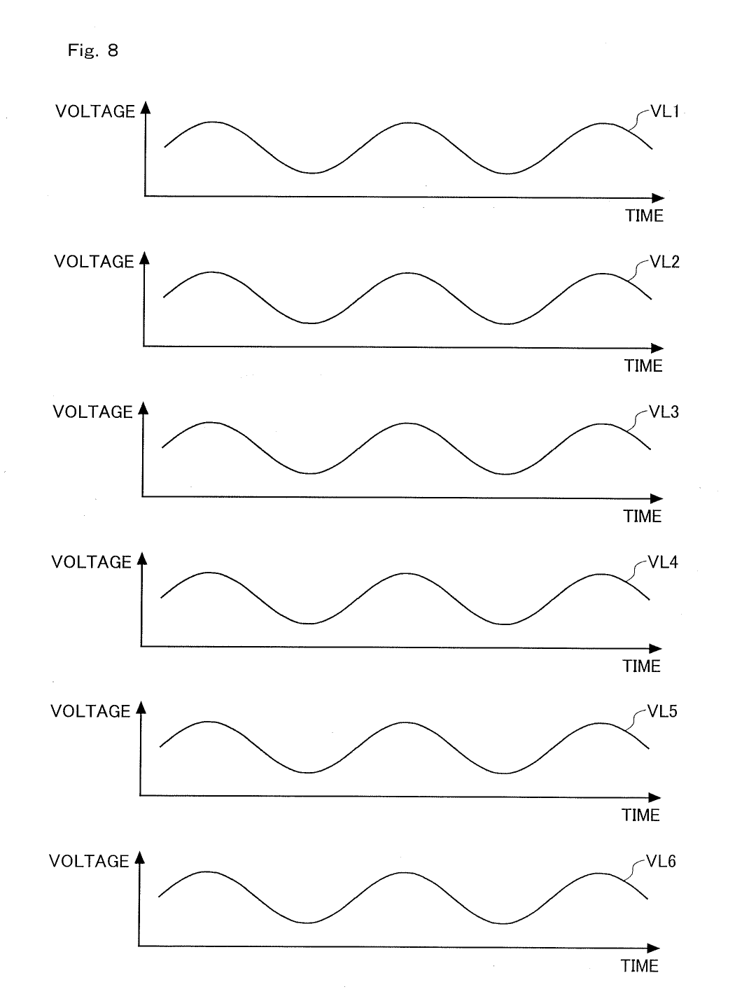

The control portion 3′ controls the DC/AC converter portions 1-1 to 1-6 so that the output voltages V1 to V6 of the DC/AC converter portions 1-1 to 1-6 are of the same frequency and phase. Consequently, as shown in FIG. 8, output voltages (lamp application voltages) VL1 to VL6 of the booster portions 2-1 to 2-6 are of the same frequency and phase.

List of Citations

### Patent Literature

Patent Document 1: JP-A-2005-283657

### SUMMARY OF THE INVENTION

### Technical Problem

Since, as described above, the output voltages (lamp application voltages) VL1 to VL6 of the booster portions 2-1 to 2-6 are of the same frequency and phase, electromagnetic waves (extraneous radiation) generated from respective transformers of the booster portions 2-1 to 2-6 are also of the same frequency or have frequencies that are integral multiples of one another. This has led to a problem that a peak value of extraneous radiation at a predetermined frequency (a driving frequency of each of the transformers of the booster portions 2-1 to 2-6) becomes large.

Patent Document 1 proposes an inverter device that, while it does not perform the in-phase driving operation, prevents noise from occurring due to a leakage current by sequentially shifting lamp application voltages in phase by a phase difference corresponding to a time period T/N, i.e. one cycle T of each of the lamp application voltages divided by N representing the number of discharge tube lamps. The inverter device proposed in Patent Document 1, therefore, is intended to prevent noise from occurring due toa leakage current and not to prevent a peak value of extraneous radiation at a predetermined frequency from becoming large.

With the foregoing situations in view, it is an object of the present invention to provide an inverter device that can reduce a peak of extraneous radiation, as well as a lighting device for a display apparatus and a display apparatus, which include the same.

### Solution to the Problem

In order to achieve the above-described object, an inverter device according to the present invention is an inverter device that includes a plurality of transformers and is used for driving a plurality of discharge tube lamps by using output voltages of the plurality of transformers as voltages to be applied to the plurality of discharge tube lamps, respectively. In the inverter device, at least one of respective driving frequencies of the plurality of transformers is shifted at predetermined time intervals.

The above-described configuration, i.e.“an inverter device that . . . is used for driving a plurality of discharge tube lamps by using output voltages of the plurality of transformers as voltages to be applied to the plurality of discharge tube lamps, respectively”is intended to also encompass a configuration in which a filter circuit or the like is provided between each of the transformers and a corresponding one of the discharge tube lamps, and output voltages of the plurality of transformers are applied to the plurality of discharge tube lamps via the filter circuits or the like, respectively. Furthermore, the predetermined time intervals may be fixed or variable. Furthermore, in a case where more than one of the respective driving frequencies of the plurality of transformers are shifted at the predetermined time intervals, they may be made to vary at the same timing or at timings shifted from one another.

Furthermore, all the respective driving frequencies of the plurality of transformers may be shifted at predetermined time intervals.

Furthermore, at least one of the respective driving frequencies of the plurality of transformers may be consistently different in value from others of the driving frequencies.

Furthermore, the respective driving frequencies of the plurality of transformers may be consistently different in value from one another.

Furthermore, in order to achieve the above-described object, a lighting device for a display apparatus according to the present invention includes the inverter device having any one of the above-described configurations and a plurality of discharge tube lamps that are driven by the inverter device.

Furthermore, in order to achieve the above-described object, a display apparatus according to the present invention includes the lighting device for a display apparatus having the above-described configuration.

Furthermore, the display apparatus may be a television receiver.

Advantageous Effects of the Invention

According to the present invention, at least one of respective driving frequencies of a plurality of transformers included in an inverter device is shifted at predetermined time intervals, and thus a peak point of extraneous radiation is smoothed to reduce a peak value of the extraneous radiation.

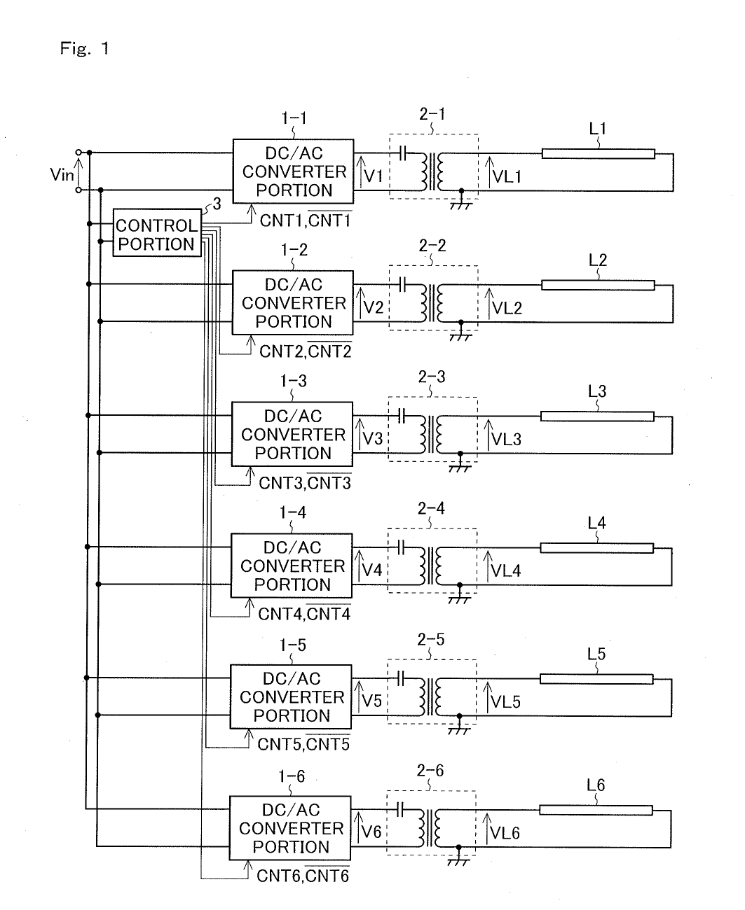

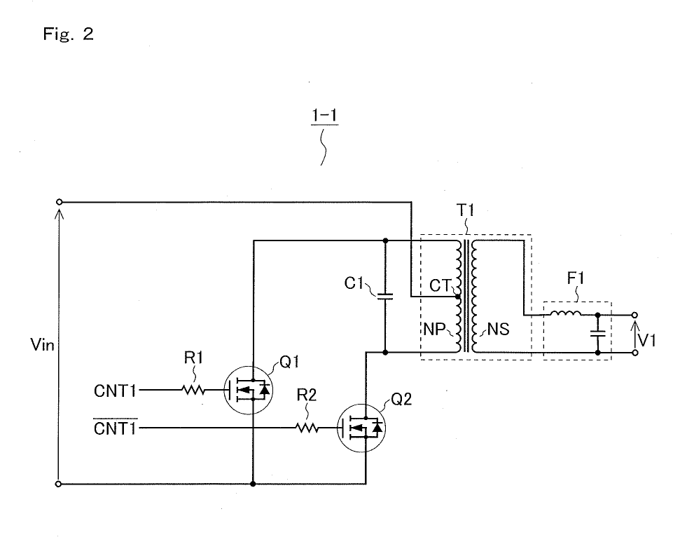

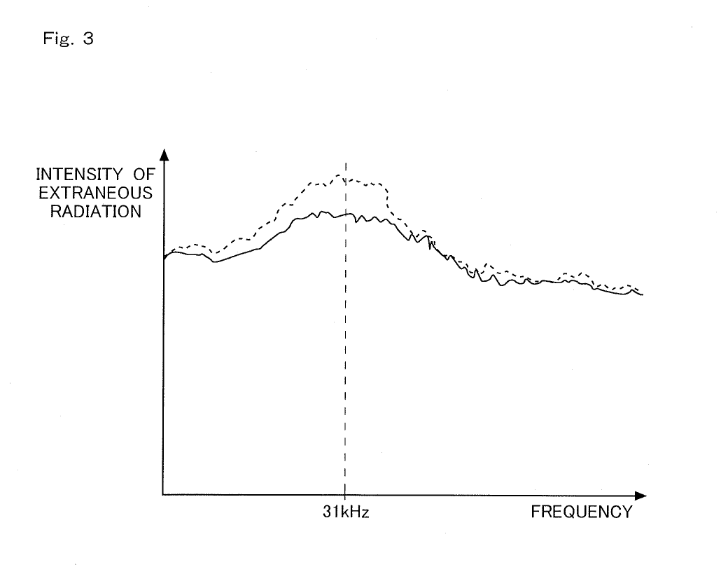

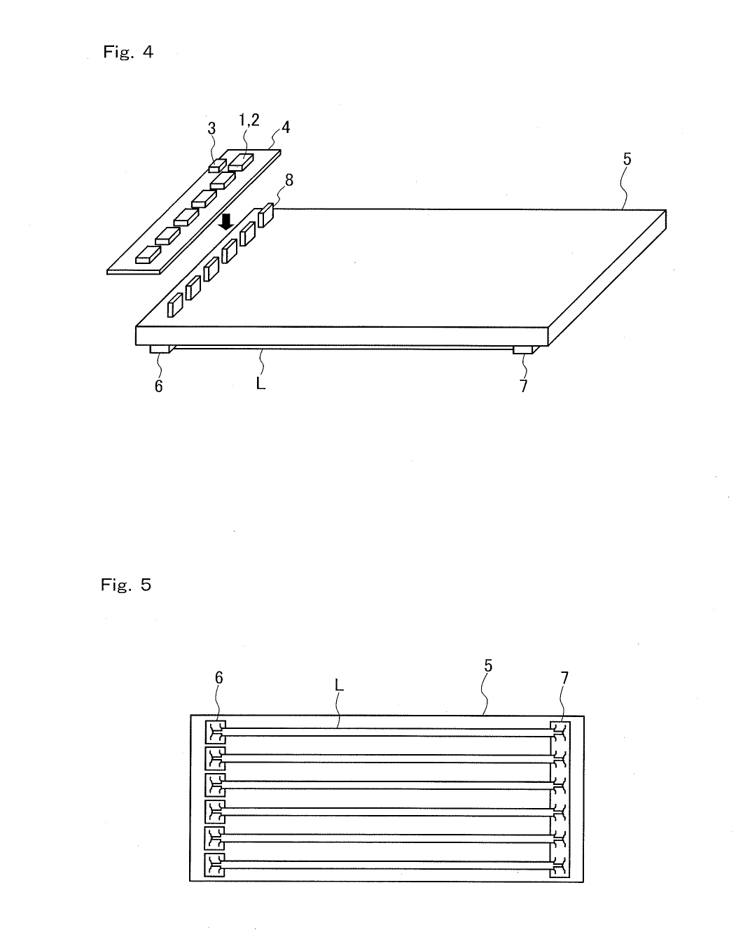

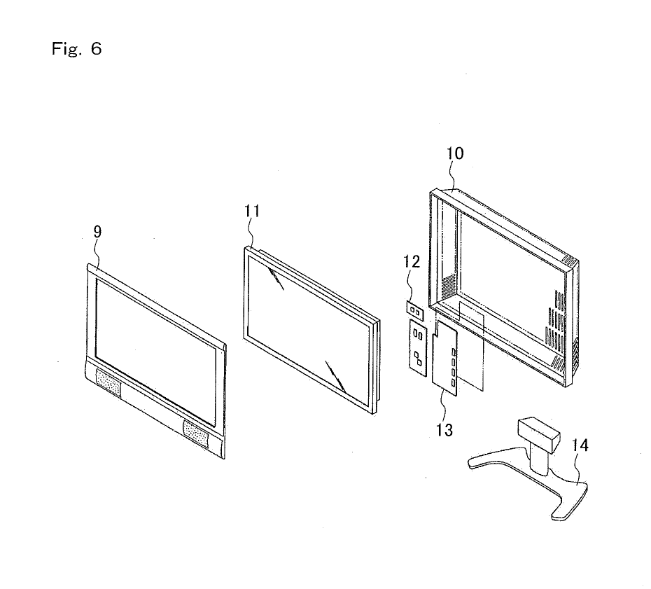

### BRIEF DESCRIPTION OF DRAWINGS

[FIG. 1] A view showing a configuration of an inverter device according to one embodiment of the present invention.

[FIG. 2] A view showing one configuration example of a DC/AC converter portion.

[FIG. 3] A diagram showing extraneous radiation that occurs in the inverter device shown in FIG. 1 and extraneous radiation that occurs in an inverter device shown in FIG. 7.

[FIG. 4] A perspective rear side view of a lighting device for a display apparatus according to one embodiment of the present invention.

[FIG. 5] A front view of the lighting device for a display apparatus according to one embodiment of the present invention.

[FIG. 6] An exploded perspective view of a liquid crystal television receiver as one example of a display device according to the present invention.

[FIG. 7]A view showing a configuration example of a conventional general-useinverter device that performs an in-phase driving operation.

[FIG. 8]A diagram showing waveforms of lamp application voltages used in the inverter device shown in FIG. 7.

### DESCRIPTION OF EMBODIMENTS

The following describes embodiments of the present invention with reference to the appended drawings.

### <<Inverter Device According to One Embodiment of the Present Invention>>

FIG. 1 shows a configuration of an inverter device according to one embodiment of the present invention. In FIG. 1, parts identical to those shown in FIG. 7 are identified by the same reference symbols, and detailed descriptions thereof are omitted.

The inverter device shown in FIG. 1 according to one embodiment of the present invention has a configuration obtained by removing the control portion 3′from the conventional general-useinverter device shown in FIG. 7, which performs the in-phase driving operation, and by providing, instead, a control portion 3 therein. The control portion 3 will be described later in detail.

Now, FIG. 2 shows one configuration example of a DC/AC converter portion 1-1 included in the inverter device shown in FIG. 1 according to one embodiment of the present invention. In the configuration example shown in FIG. 2, the DC/AC converter portion 1-1 is a push-pull type DC/AC converter circuit and includes switching elements Q1 and Q2, resistors R1 and R2, a capacitor C1, a transformer T1, and a low-pass filter circuit F1.

The switching elements Q1 and Q2 are constituted by an N-channel enhancement type MOS transistor and a feedback diode that is connected in antiparallel with the transistor, respectively. A first PWM (pulse width modulation) control signal CNT1 outputted from the control portion 3 (see FIG. 1) is supplied to a gate of the switching element Q1 via the resistor R1, and a first inverted PWM control signal CNT1 with an overbar is supplied to a gate of the switching element Q2 via the resistor R2. Since the first inverted PWM control signal CNT1 with an overbar is an inverted signal of the first PWM control signal CNT1, the switching elements Q1 and Q2 are complementarily switched between an on state and an off state.

The transformer T1 has a primary winding NP and a secondary winding

NS, and the primary winding NP is provided with a center tap CT. A drain of the switching element Q1 and one end of the capacitor C1 are connected to one end of the primary winding NP, while a drain of the switching element Q2 and the other end of the capacitor C2 are connected to the other end of the primary winding NP, and a source of the switching element Q1 and a source of the switching element Q2 are commonly connected. A direct current input voltage Vin is applied between a common connection point at which the sources of the switching elements Q1 and Q2 are commonly connected and the center tap CT.

Since the switching elements Q1 and Q2 are complementarily switched between on and off states, an electric current flows alternately through a connection line between the drain of the switching element Q1 and the one end of the primary winding NP and through a connection line between the source of the switching element Q1 and the source of the switching element Q2, and thus the flow direction of an electric current flowing through the primary winding NP is switched, so that a rectangular waveform voltage is generated across the secondary winding NS. The rectangular waveform voltage generated across the secondary winding NS is rectified to a sinusoidal voltage V1 by the low-pass filter circuit F1. A leakage inductor of the transformer T1 may be used as an inductor that is one component constituting the low-pass filter circuit F1.

The sinusoidal voltage V1, after being outputted from the DC/AC converter portion 1-1, is boosted by a booster portion 2-1 (see FIG. 1) to a sinusoidal high voltage VL1 that is then applied across a discharge tube lamp L1 (see FIG. 1).

As for each of DC/AC converter portions 1-2 to 1-6, one configuration example thereof is similar to that of the DC/AC converter portion 1-1 shown in FIG. 2, and a duplicate description thereof is therefore omitted.

Next, the following describes the control portion 3. The control portion 3 generates and outputs the first PWM control signal CNT1 and the first inverted PWM control signal CNT1 with an overbar to the DC/AC converter portion 1-1, a second PWM control signal CNT2 and a second inverted PWM control signal CNT2 with an overbar to the DC/AC converter portion 1-2, a third PWM control signal CNT3 and a third inverted PWM control signal CNT3 with an overbar to the DC/AC converter portion 1-3, a fourth PWM control signal CNT4 and a fourth inverted PWM control signal CNT4 with an overbar to the DC/AC converter portion 1-4, a fifth PWM control signal CNT5 and a fifth inverted PWM control signal CNT5 with an overbar to the DC/AC converter portion 1-5, and a sixth PWM control signal CNT6 and a sixth inverted PWM control signal CNT6 with an overbar to the DC/AC converter portion 1-6.

### <One Operation Example of the Control Portion>

The control portion 3 has a timer function and generates the control signals CNT1 to CNT6 and CNT1 with an overbar to CNT6 with an overbar such that, as shown in Table 1 below, driving frequencies f1 to f6 respective frequencies of lamp application voltages VL1 to VL6) of respective transformers of the booster portions 2-1 to 2-6 are shifted by 1 kHz at predetermined time intervals t. This can be easily achieved by changing a PWM cycle of each of the control signals CNT1 to CNT6 and CNT1 with an overbar to CNT6 with an overbar at the predetermined time intervals t. The timer function of the control portion 3 is set so that when a timer time TM reaches 6t, it is automatically reset to 0. Furthermore, there is no particular limitation on the predetermined time intervals t.

TABLE 1

| | | | | | 4t ≦ | 5t ≦ |
|---|---|---|---|---|---|---|
| | 0 ≦ M < | t ≦ TM < | 2t ≦ TM < | 3t ≦ TM < | TM < | TM < |
| | t | 2t | 3t | 4t | 5t | 6t |
| f1 | 31 | 32 | 33 | 34 | 35 | 36 |
| f2 | 31 | 32 | 33 | 34 | 35 | 36 |
| f3 | 31 | 32 | 33 | 34 | 35 | 36 |
| f4 | 31 | 32 | 33 | 34 | 35 | 36 |
| f5 | 31 | 32 | 33 | 34 | 35 | 36 |
| f6 | 31 | 32 | 33 | 34 | 35 | 36 |

Now, FIG. 3 shows a result of a comparison between extraneous radiation that occurs in the inverter device shown in FIG. 1 according to one embodiment of the present invention and extraneous radiation that occurs in the conventional general-use inverter device shown in FIG. 7 in a case where frequencies of the lamp application voltages VL1 to VL6 are set to 31 kHz. In FIG. 3, a solid line indicates the extraneous radiation that occurs in the inverter device shown in FIG. 1 according to one embodiment of the present invention, and a dotted line indicates the extraneous radiation that occurs in the conventional general-use inverter device shown in FIG. 7.

In a case of the inverter device shown in FIG. 1 according to one embodiment of the present invention, since the driving frequencies (=respective frequencies of the lamp application voltages VL1 to VL6) of the respective transformers of the booster portions 2-1 to 2-6 are shifted by 1 kHz at the predetermined time intervals t, as is apparent from FIG. 3, compared with a case of the conventional general-use inverter device shown in FIG. 7, a peak point of the extraneous radiation is smoothed to reduce a peak value of the extraneous radiation.

### <Another Operation Example of the Control Portion>

In a case where the driving frequencies f1 to f6 of the respective transformers of the booster portions 2-1 to 2-6 are set as shown in Table 1 above, however, when considering an extremely short time period (<the predetermined time interval t), a peak point of extraneous radiation cannot be smoothed. It is therefore more preferable to set the driving frequencies f1 to f6 of the respective transformers of the booster portions 2-1 to 2-6 as shown in Table 2 below so that, even when considering an extremely short time period(<the predetermined time interval t), a peak point of extraneous radiation can be smoothed.

TABLE 2

| | | | | | 4t ≦ | 5t ≦ |
|---|---|---|---|---|---|---|
| | 0 ≦ TM < | t ≦ TM < | 2t ≦ TM < | 3t ≦ TM < | TM < | TM < |
| | t | 2t | 3t | 4t | 5t | 6t |
| f1 | 31 | 32 | 33 | 34 | 35 | 36 |
| f2 | 32 | 33 | 34 | 35 | 36 | 31 |
| f3 | 33 | 34 | 35 | 36 | 31 | 32 |
| f4 | 34 | 35 | 36 | 31 | 32 | 33 |
| f5 | 35 | 36 | 31 | 32 | 33 | 34 |
| f6 | 36 | 31 | 32 | 33 | 34 | 35 |

### <Modified Example of the Operation of the Control Portion>

In each of Tables 1 and 2 above, all the driving frequencies f1 to f6 of the respective transformers of the booster portions 2-1 to 2-6 are made to vary at the predetermined time intervals t. The present invention, however, is not limited thereto and only requires that at least one of the driving frequencies f1 to f6 of the respective transformers of the booster portions 2-1 to 2-6 be made to vary.

Furthermore, in each of Tables 1 and 2 above, the driving frequencies f1 to f6 of the respective transformers of the booster portions 2-1 to 2-6 are made to vary by 1 kHz at the predetermined time intervals t. The present invention, however, is not limited thereto. That is, there is not particular limitation on the amount of variations in the driving frequencies f1 to f6 of the respective transformers of the booster portions 2-1 to 2-6.

Furthermore, in each of Tables 1 and 2 above, all the driving frequencies f1 to f6 of the respective transformers of the booster portions 2-1 to 2-6 are made to vary at the same timing. The present invention, however, is not limited thereto, and the driving frequencies f1 to f6 of the respective transformers of the booster portions 2-1 to 2-6 may be made to vary at timings shifted from one another.

Furthermore, the predetermined time intervals t may be fixed or variable depending on an elapsed time, conditions of the device, or the like.

### <<Lighting Device for a Display Apparatus According to One Embodiment of the Present Invention>>

FIG. 4 shows a perspective rear side view of a lighting device for a display apparatus according to one embodiment of the present invention, and FIG. 5 shows a front view thereof In FIG. 4, parts identical to those shown in FIG. 1 are identified by the same reference symbols. Furthermore, in each of FIGS. 4 and 5, reference symbol 1 represents any one of reference symbols 1-1 to 1-6 (see FIG. 1), reference symbol 2 represents any one of reference symbols 2-1 to 2-6 (see FIG. 1), and reference symbol L represents any one of reference symbols L1 to L6 (see FIG. 1).

The lighting device for a display apparatus shown in FIGS. 4 and 5 according to one embodiment of the present invention includes the inverter device shown in FIG. 1 according to one embodiment of the present invention (hereinafter, referred to simply as the “inverter device”), an inverter substrate 4, a chassis 5, and six discharge tube lamps L.

The inverter device is mounted on the inverter substrate 4.

Each of the discharge tube lamps L is held at one end by a first holder 6 that is provided on a front surface of the chassis 5 and at the other end by a second holder 7 that is provided on the front surface of the chassis 5. Furthermore, on a rear surface of the chassis 5, six connectors 8 are each provided at a position corresponding to the first holder 6. One end terminal of each of the discharge tube lamps L is electrically connected to a connecter terminal of each of the connectors 8 via the first holder 6 having electrical conductivity, while the other end terminal thereof is commonly connected to a ground potential via the second holder 7 having electrical conductivity.

On a surface of the inverter substrate 4 opposite to a surface thereof on which the inverter device is mounted, an inverter-side connector (not shown) paired with each of the connectors 8 is provided. One output end of each of the booster portions 2 is electrically connected to a connecter terminal of the inerter-side connector, while the other output end thereof is connected to the ground potential.

The inverter substrate 4 is mounted to the rear surface of the chassis 5 in a direction indicated by an arrow in FIG. 4, so that the connectors 8 on the chassis 5 are connected to the inverter-side connectors (not shown) on the inverter substrate 4, respectively. Establishing connection in this manner enables the inverter device to drive the plurality of discharge tube lamps L.

### <<Display Apparatus According to One Embodiment of the Present Invention>>

A display apparatus according to one embodiment of the present invention has a configuration including the lighting device for a display apparatus shown in FIGS. 4 and 5 according to one embodiment of the present invention and a display panel. More specifically, the display apparatus according to one embodiment of the present invention takes the form of, for example, a transmission type liquid crystal display apparatus that uses, as a backlight unit, the lighting device for a display apparatus shown in FIGS. 4 and 5 according to one embodiment of the present invention and has a liquid crystal display panel provided in front of the lighting device.

Now, FIG. 6 shows, as one example, an exploded perspective view of a liquid crystal television receiver used as the display apparatus according to one embodiment of the present invention. A transmission type liquid crystal display portion 11, a tuner 12, and a power source 13 are housed between a front cabinet 9 and a rear cabinet 10, and the rear cabinet 10 is held by a stand 14. The transmission type liquid crystal display portion 11 uses, as a backlight unit, the lighting device for a display apparatus shown in FIGS. 4 and 5 according to one embodiment of the present invention and has a liquid crystal display panel provided in front of the lighting device. Furthermore, the power source 13 converts a commercial alternating current voltage into a direct current voltage and supplies the direct current voltage to various parts including the transmission type liquid crystal display portion 11, the tuner 12, and so on.

### <<Other Modifications and Variations>>

While the foregoing has described the embodiments according to the present invention, the scope of the present invention is not limited thereto, and various modifications are possible without departing from the spirit of the invention. For example, in the inverter device according to one embodiment of the present invention, a filter circuit or the like maybe provided between each of the booster portions 2-1 to 2-6 and a corresponding one of the discharge tube lamps L1 to L6.

### INDUSTRIAL APPLICABILITY

The inverter device of the present invention is applicable for driving a plurality of discharge tube lamps.

### LIST OF REFERENCE SYMBOLS

1, 1-1 to 1-6 DC/AC converter portion

2, 2-1 to 2-6 booster portion

3, 3′ control portion

4 inverter substrate

5 chassis

6 first holder

7 second holder

8 connector

9 front cabinet

10 rear cabinet

11 transmission type liquid crystal display portion

12 tuner

13 power source

14 stand

C1 capacitor

CT center tap

F1 low-pass filter circuit

L, L1 to L6 discharge tube lamp

NP primary winding

NS secondary winding

Q1, Q2 switching element

R1, R2 resistor

T1 transformer

1. An inverter device that comprises a plurality of transformers and is used for driving a plurality of discharge tube lamps by using output voltages of the plurality of transformers as voltages to be applied to the plurality of discharge tube lamps, respectively,
wherein at least one of respective driving frequencies of the plurality of transformers is shifted at predetermined time intervals.

2. The inverter device according to claim 1, wherein
all the respective driving frequencies of the plurality of transformers are shifted at predetermined time intervals.

3. The inverter device according to claim 1, wherein
at least one of the respective driving frequencies of the plurality of transformers is consistently different in value from others of the driving frequencies.

4. The inverter device according to claim 3, wherein
the respective driving frequencies of the plurality of transformers are consistently different in value from one another.

5. A lighting device for a display apparatus, comprising:
the inverter device according to claim 1; and
a plurality of discharge tube lamps that are driven by the inverter device.

6. A display apparatus comprising the lighting device for a display apparatus according to claim 5.

7. The display apparatus according to claim 6, wherein the display apparatus is a television receiver.
